(19) United States
(12) Patent Application Publication
(10) Pub. No.: US 2015/0253985 A1
(43) Pub. Date: Sep. 10, 2015

(54) SYSTEM AND METHOD FOR CONTROLLING DISPLAY OF VIRTUAL KEYBOARD TO AVOID OBSCURING DATA ENTRY FIELDS

(71) Applicant: AVOCENT HUNTSVILLE CORP., Huntsville, AL (US)

(72) Inventor: Craig S. Siegman, Pembroke Pines, FL (US)

(73) Assignee: AVOCENT HUNTSVILLE CORP., Huntsville, AL (US)

(21) Appl. No.: 14/436,215

(22) PCT Filed: Oct. 17, 2013
(86) PCT No.: PCT/US2013/065352

§ 371 Date: Apr. 16, 2015

Related U.S. Application Data
(60) Provisional application No. 61/714,989, filed on Oct. 17, 2012.

(51) Int. Cl. G06F 3/0488; G06F 3/0485; G06F 3/041

(52) U.S. Cl. CPC G06F 3/04886; G06F 3/041; G06F 3/0485

(57) ABSTRACT

An electronic device is disclosed having a touchscreen display. The electronic device may incorporate an application running on the electronic device, the application being configured to generate a field on the touchscreen display (“display”) that requires a user to enter keystroke information into the field. The application may incorporate a virtual keyboard display control subsystem (“subsystem”) configured to determine if generation of the virtual keyboard on the display will obscure the field when the field is being displayed on the display. The subsystem may also automatically scroll the field to a location on the display when the virtual keyboard is generated on the display, such that the virtual keyboard does not obscure the field as the user enters keystroke information into the field using the virtual keyboard.

### CROSS-REFERENCE TO RELATED APPLICATIONS

This application claims priority to U.S. Provisional Application No. 61/714,989, filed on Oct. 17, 2012. The entire disclosure of the above application is incorporated herein by reference.

### FIELD

The present disclosure relates to applications that run on portable electronic devices, such as computing tablets and smartphones, and more particularly to an application that controls generation of a virtual keyboard on a touchscreen display of the portable electronic device in a manner that positions the virtual keyboard such that it does not obscure any portion of a field being displayed on the touchscreen display as keystroke data is entered using the virtual keyboard.

### BACKGROUND

The statements in this section merely provide background information related to the present disclosure and may not constitute prior art.

With mobile computing devices such as computing tablets, smartphones and other like devices, a touchscreen is typically incorporated. When using a web browser, the user is typically provided with one or more well defined fields in which one or more specific items of information may be entered by the user. However, if an application is being used which is not a web browser, and the application is being used to communicate with a host (i.e., remote) server's desktop, the application typically will not know exactly where the defined fields are on the host server's desktop. Thus, when an application (i.e., a non-web browser application) running on the device requires a response from the user, the device (typically the operating system) generates a virtual keyboard that is displayed on the touchscreen display. Typically the application will also present a box or field on the display where the keystroke data that the user is entering may be displayed as the user enters keystroke data using the virtual keyboard. But as noted above, this is not a well-defined field like what would be present in a web browser. And neither the operating system nor the application knows the exact location of the field on the touchscreen display. So when the virtual keyboard is generated, frequently it is positioned over the field which displays the keystroke data that the user is typing in. As a result, the user cannot see the keystroke data that he/she has just typed in, and cannot be sure that he/she has entered the response that was intended.

### SUMMARY

In one aspect the present disclosure relates to an electronic device having a touchscreen display. The electronic device may comprise an application running on the electronic device, the application being configured to generate a field on the touchscreen display that requires a user to enter keystroke information into the field. The application may include a virtual keyboard display control subsystem configured to determine if generation of the virtual keyboard on the touchscreen display will obscure the field when the field is being displayed on the touchscreen display. The virtual keyboard display control subsystem may also automatically scroll the field to a location on the touchscreen display when the virtual keyboard is generated on the touchscreen display, such that the virtual keyboard does not obscure the field as the user enters keystroke information into the field using the virtual keyboard.

In another aspect the present disclosure relates to a method for controlling a location of a virtual keyboard being displayed on a touchscreen display so as not to obscure an input field being displayed on the touchscreen display when the virtual keyboard is generated. The method may comprise using a virtual keyboard display control subsystem configured to determine, based on available display area of the touchscreen display and a size of the field being displayed, if generation of the virtual keyboard on the touchscreen display will obscure the field. When it is determined that generation of the virtual keyboard will obscure at least part of the field, then the virtual keyboard display control subsystem may automatically perform at least one of the following operations: scrolling the field to a location on the touchscreen display when the virtual keyboard is generated on the touchscreen display such that the virtual keyboard does not obscure the field as the user enters keystroke information into the field using the virtual keyboard; or positioning the virtual keyboard on the touchscreen display at a location that does not obscure the field.

In still another aspect the present disclosure may relate to a method for controlling a location of a virtual keyboard being displayed on a touchscreen display so as not to obscure an input field being displayed on the touchscreen display when the virtual keyboard is generated. The method may comprise using a virtual keyboard display control subsystem configured to generate a tag on the virtual keyboard. The tag allows a user to selectively drag the virtual keyboard around on the touchscreen display with a finger. In this manner the location of the virtual keyboard may be controlled to avoid having the virtual keyboard obscure the input field while the virtual keyboard is being used by the user.

In still another aspect the present disclosure may comprise a method for controlling a location of a virtual keyboard being displayed on a touchscreen display so as not to obscure an input field being displayed on the touchscreen display when the virtual keyboard is generated. The method may comprise using a virtual keyboard display control subsystem configured to generate a touch control on the virtual keyboard which allows a user to change dimensions of the virtual keyboard by touching the touch control. In this manner the location of the virtual keyboard may be controlled so that the virtual keyboard does not obscure the field when the virtual keyboard is generated.

### BRIEF DESCRIPTION OF THE DRAWINGS

The drawings described herein are for illustration purposes only and are not intended to limit the scope of the present disclosure in any way.

FIG. 1 is a simplified illustration of a portable electronic computing device, such as a computing tablet, incorporating an application which includes a virtual keyboard display control subsystem for controlling the positioning of the virtual keyboard on a touchscreen display;

FIG. 2 shows the device of FIG. 1, but with the display scrolled upward so that the shaded field where keystroke data is entered is not obscured by any portion of the virtual keyboard when the user is entering keystroke data using the virtual keyboard; and

FIG. 3 is a flowchart illustrating one example of the operations that may be performed in controlling placement of the virtual keyboard on the touchscreen display to avoid having the virtual keyboard obscure a data entry field when the virtual keyboard is displayed.

### DETAILED DESCRIPTION

The following description is merely exemplary in nature and is not intended to limit the present disclosure, application, or uses. It should be understood that throughout the drawings, corresponding reference numerals indicate like or corresponding parts and features.

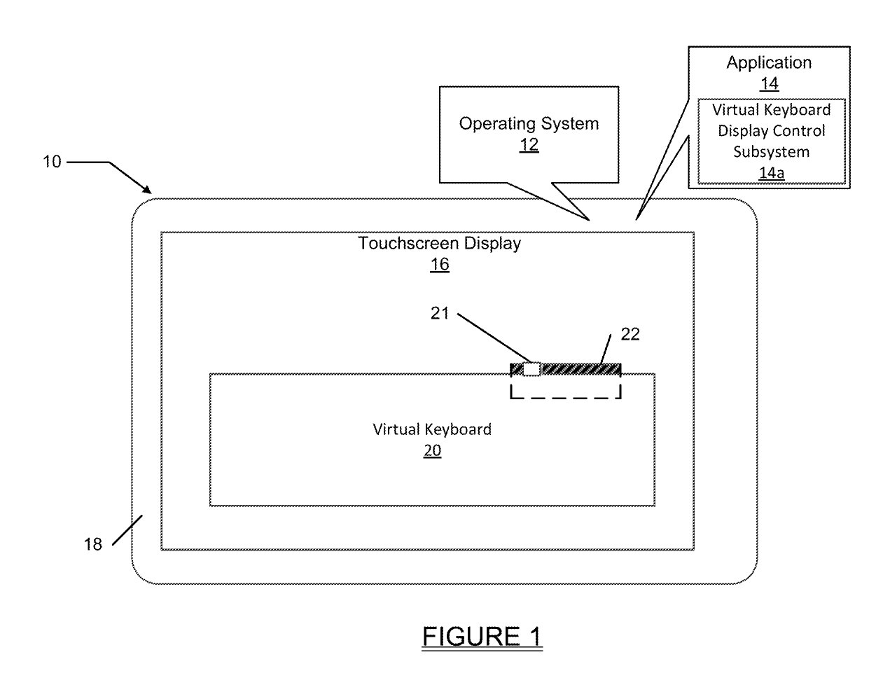

Referring to FIG. 1 there is shown a mobile (i.e., portable) electronic device 10 having an operating system 12 and running an application 14. The electronic device 10 may be a computing tablet, smartphone, or any other form of portable electronic device having a touchscreen display 16 that is supported within a housing 18. A virtual keyboard 20 may be generated on the touchscreen display 16 by the application 14 when data needs to be entered by the user. The operating system 12 may be any suitable operating system, for example and without limitation, the iOS operating system used by Apple Computing, Inc. of Cupertino, Calif., or the ANDROID™ operating system by Google, Inc., of Mountain View, Calif. The application 14 may be any type of application, but in one example may be a remote presence application, for example a KVM (Keyboard/Video/Mouse) remote presence application, for communicating with a remote server (not shown) via a suitable network connection.

Typically in a known, conventional portable electronic device that makes use of a touchscreen display, the operating system running on the device will generate the virtual keyboard 20 when a response is required from the user. The application running on the device will typically have a data entry area or “field” in which the keystroke data typed in by the user on the virtual keyboard will be shown as the user the enters keystrokes from the virtual keyboard. However, neither the application nor the operating system running on the electronic device 10 (e.g., tablet or smartphone) will know exactly where the defined entry field is on the touchscreen display 16. As such, this is fundamentally different from a typical web browser application, where the locations of the defined entry fields will be known to the operating system or application running on the electronic device 10. Thus, when the virtual keyboard is generated, the operating system or the application may position the virtual keyboard over all or a portion of the field where the keystroke data the user types in will be displayed. This condition is shown in FIG. 1, where field 22 represents the area on the touchscreen display 16 where characters (letters, numbers or symbols) being typed in by the user on the virtual keyboard 20 will be partially or completely obscured by the virtual keyboard 20. As such, as the user types in keystroke data on the virtual keyboard 20, he/she will not be able to see the data that has just been typed within the field 22. Accordingly, the user will not be certain that he/she has actually entered the response that was intended.

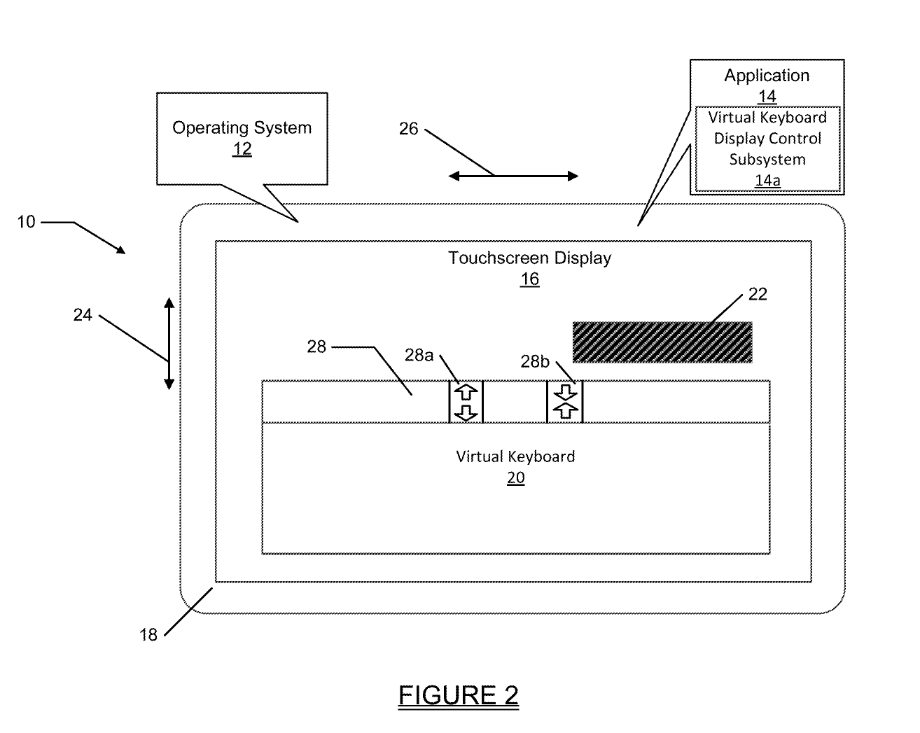

The above problem is addressed by providing the application 14 with a virtual keyboard display control subsystem 14a, as shown in FIGS. 1 and 2. The display control subsystem 14a in this example forms a portion of the application 14 and operates to determine if displaying the virtual keyboard 20 will cause all or part of the field 22 to be obscured by the virtual keyboard, based on the last known position of a cursor 21 on the touchscreen 16. If so, then the display control subsystem 14a may scroll the display up or down, as indicated by arrow 24 in FIG. 2, or even horizontally left or right, as indicated by arrow 26, so that the field 22 will be fully visible when the virtual keyboard 20 is generated for display on the touchscreen display 16. In FIG. 2 it will be apparent that the entire display being presented on the touchscreen display 16 has been scrolled up from the position it was shown in FIG. 1 in order to be able to display the virtual keyboard 20 without blocking any of the field 22. Optionally, or in addition to the automatic horizontal and vertical scrolling described above, the application 14 may provide the virtual keyboard 20 with a tag 28. By touching the tag 28 with a finger and dragging the finger across the touchscreen display 16, the user can position (i.e., drag) the virtual keyboard 20 to a precise location on the touchscreen display so that other information being presented on the touchscreen display, in addition to the field 22, is not obscured by the virtual keyboard. Thus, the user may be provided with the capability of further modifying the placement of the virtual keyboard 20 from the location selected by the display control subsystem 14a.

Still further, the application 14 may enable the virtual keyboard 20 to be resized by the user placing two fingers on the virtual keyboard 20 and moving his/her fingers toward one another, to make the virtual keyboard 20 smaller, or moving the fingers away from one another, to make the virtual keyboard 20 larger. Thus, the user can position and/or resize the virtual keyboard 20 as needed to avoid having it cover the field 22. Alternatively, the application 14 may require that such resizing be done with the user's fingers touching an “enlarge” symbol 28a within the area defined by the tag 28, which enlarges the virtual keyboard 20, or by touching a “reduce” symbol 28b on the tag 28, which reduces the size of the virtual keyboard 20. Any other suitable method for allowing easy user resizing of the virtual keyboard 20, for example a virtual thumbwheel, could be implemented, and the present disclosure is not limited to any one particular resizing methodology. The resizing features described above may be incorporated with or without use of the tag 28.

Still further, the virtual keyboard display control subsystem 14a may sense the last spot on the touchscreen display 16 that was touched by the user. For example, consider that the user has just touched, that is “selected”, field 22, which is being displayed on the touchscreen display 16, in order to enter information into the field 22. The virtual keyboard display control subsystem 14a may then generate the virtual keyboard 20 at a location that is vertically and/or horizontally offset from the last-touched position on the touchscreen display 16, that is, the location where field 22 is being presented, so that the virtual keyboard 20 does not cover any portion of the field 22.

As another variant, the user may touch a specific location on the touchscreen display 16 to select the position of the field 22. In this instance the virtual keyboard display control subsystem 14a may prompt the user with a query on the touchscreen display 16 to touch the specific area of the touchscreen display 16 where keystroke data is going to be displayed, and then may determine where the virtual keyboard 20 should be positioned on the touchscreen display 16 in order to avoid covering any portion of the field 22. As still another variant, the virtual keyboard display control subsystem 14a may consider the last point where the mouse or cursor 21 was placed on the touchscreen display 16. For example, consider that the user has positioned the mouse or cursor 21 over field 22, and then made a selection to select the field 22 as the field where information is to be entered. The display control subsystem 14a may use the last position of the mouse or cursor 21 to generate the virtual keyboard 20 at a place on the touchscreen display 16 where it will not cover any portion of the field 22. It is also possible that two or more of the variants described above may be combined by the display control subsystem 14a.

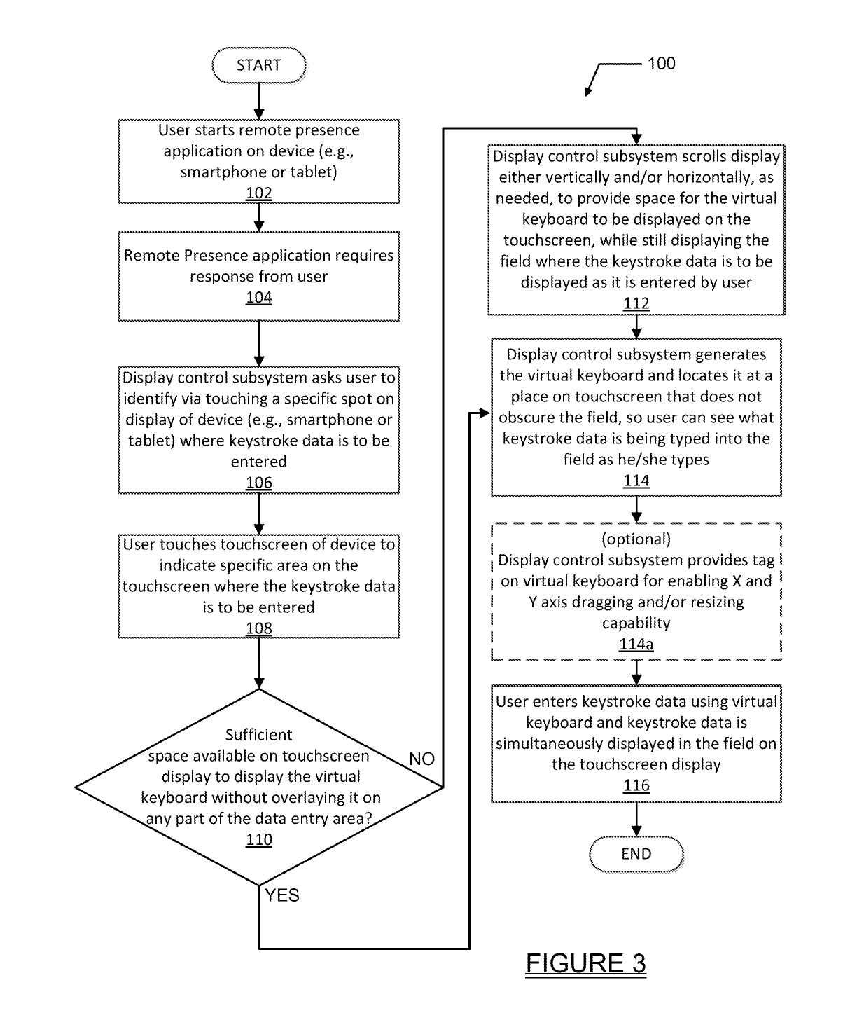

Referring now to FIG. 3, a flowchart 100 illustrates one example of the various operations that may be performed when the application 14 controls the display and positioning of the virtual keyboard 20 on the touchscreen display 16. In this example a remote presence application is the application 14 that is running on the device 10, although as mentioned above the application 14 could be any other type of application that is able to run on a mobile computing device with a touchscreen display.

At operation 102 the user starts the remote presence application 14 on the device 10. At operation 104 the remote presence application 14 requires a response from the user. At operation 106 the display control subsystem 14a of the application 14 asks the user to identify, via touching a specific spot on the touchscreen display 16, where keystroke data is to be displayed as it is being entered by the user from the virtual keyboard 20, in order to denote the position of the field 22. As explained above, an alternative methodology would be for the display control subsystem 14a to determine the last-touched location on the touchscreen display 16 or the last known location of the cursor 21 in order to denote the position of the field 22. For this example, however, it will be assumed that the display control subsystem 14a makes a specific inquiry that requires the user to denote where the keystroke data is to be displayed on the touchscreen display 16.

At operation 108 the user touches the touchscreen display 16 to indicate the specific area (i.e., field 22) on the touchscreen display where the keystroke data is to be entered. At operation 110 the display control subsystem 14a makes a determination as to whether sufficient space is available on the touchscreen display 16 to display the virtual keyboard 20 in full. If this inquiry produces a “No” answer, then at operation 112 the display control subsystem 14a scrolls the display vertically and/or horizontally as needed, to provide space for the virtual keyboard 20 to be displayed on the touchscreen display 16, while still displaying the field 22 where the keystroke data is to be displayed as it is entered by the user.

If the inquiry at operation 110 produced a “Yes” answer, or after operation 112, at operation 114 the display control subsystem 14a generates the virtual keyboard 20 and locates it at a place on the touchscreen display 16 that does not obscure the field 22. In this manner the user is able to see the keystroke data that he/she is typing in as it is entered into the field 22 using the virtual keyboard 20. Optionally, at operation 114a, the display control subsystem 14a may provide the tag 28 on the virtual keyboard 20 for enabling the X and Y axis (horizontal and vertical) dragging and/or resizing capability discussed above.

At operation 116 the user then uses the virtual keyboard 20, and the keystroke data is simultaneously displayed in the data entry area (e.g., field 22 in FIGS. 1 and 2) on the touchscreen display 16.

From the foregoing it will be appreciated that the subject matter of the present disclosure enables a virtual keyboard to be positioned on a touchscreen display to avoid obscuring any portion of a field where the keystroke data that the user is generating will be displayed on a touchscreen display as it is typed in by the user. This eliminates the problem of the user not being able to see the keystroke data that he/she is entering because the field where the data is being entered is covered by the virtual keyboard. The system and method of the present disclosure can be implemented without any modifications to the electronic device itself, that is, the control of the positioning of the virtual keyboard, and the required scrolling of the display (if needed), are handled by the application running on the device and not by the operating system.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. An electronic device having a touchscreen display, the electronic device comprising:
an application running on the electronic device, the application being configured to generate a field on the touchscreen display that requires a user to enter keystroke information into the field;
the application including a virtual keyboard display control subsystem configured to:
determine if generation of the virtual keyboard on the touchscreen display will obscure the field when the field is being displayed on the touchscreen display; and
when it is determined that generation of the virtual keyboard on the touchscreen display will at least partially obscure the field, to automatically scroll the field to a location on the touchscreen display when the virtual keyboard is generated on the touchscreen display such that the virtual keyboard does not obscure the field, thus enabling the field to be viewed by the user when entering keystroke information into the field using the virtual keyboard.

2. The electronic device of claim 1, wherein the virtual keyboard display control subsystem automatically scrolls the field in a horizontal direction or a vertical direction to avoid having the field obscured by the touchscreen display when the touchscreen display is generated.

3. The electronic device of claim 1, wherein the virtual keyboard display control subsystem includes uses a last known location of a cursor being displayed on the touchscreen display to determine if the virtual keyboard will obscure the field when the virtual keyboard is generated.

4. The electronic device of claim 1, wherein the virtual keyboard control subsystem uses a sensed location of a last touch by user on the touchscreen display.

5. The electronic device of claim 1, wherein the virtual keyboard control subsystem generates a prompt on the touchscreen display, for the user to identify a location on the touchscreen display where the keystroke information is to be displayed, before determining how the field will need to be scrolled.

6. A method for controlling a location of a virtual keyboard being displayed on a touchscreen display so as not to obscure an input field being displayed on the touchscreen display when the virtual keyboard is generated, the method comprising:
using a virtual keyboard display control subsystem configured to:
determine, based on available display area of the touchscreen display and a size of the field being displayed, if generation of the virtual keyboard on the touchscreen display will obscure the field; and
when it is determined that generation of the virtual keyboard will obscure at least part of the field, automatically performing at least one of the following operations:
scrolling the field to a location on the touchscreen display when the virtual keyboard is generated on the touchscreen display such that the virtual keyboard does not obscure the field as the user enters keystroke information into the field using the virtual keyboard; or
positioning the virtual keyboard on the touchscreen display at a location that does not obscure the field.

7. The method of claim 6, wherein the operation of scrolling the field comprises scrolling the field in a vertical direction.

8. The method of claim 6, wherein the operation of scrolling the field comprises scrolling the field in a horizontal direction.

9. A method for controlling a location of a virtual keyboard being displayed on a touchscreen display so as not to obscure an input field being displayed on the touchscreen display when the virtual keyboard is generated, the method comprising:
using a virtual keyboard display control subsystem configured to generate a tag on the virtual keyboard which allows a user to selectively drag the virtual keyboard around on the touchscreen display with a finger, to avoid having the virtual keyboard obscure the input field while the virtual keyboard is being used by the user.

10. The method of claim 9, wherein the virtual keyboard display control subsystem further generates the virtual keyboard with a sizing control to enable a user to change a dimension of the virtual keyboard using a touch command.

11. The method of claim 10, wherein the sizing control operates to enable the user to enlarge and reduce an area of the virtual keyboard by moving two fingers toward or away from one another while the two fingers are in contact with the touchscreen display.

12. The method of claim 9, wherein the virtual keyboard display control subsystem further generates the virtual keyboard with a sizing control button to enable the user to shrink the size of the virtual keyboard by touching the sizing control button with a finger.

13. The method of claim 9, wherein the virtual keyboard display control subsystem further generates the virtual keyboard with a sizing control button to enable the user to increase the size of the virtual keyboard by touching the sizing control button.

14. The method of claim 9, wherein the virtual keyboard display control subsystem is further configured to consider a last known location of a cursor or mouse being displayed on the touchscreen display, when initially considering where on the touchscreen display to display the virtual keyboard.

15. A method for controlling a location of a virtual keyboard being displayed on a touchscreen display so as not to obscure an input field being displayed on the touchscreen display when the virtual keyboard is generated, the method comprising:
using a virtual keyboard display control subsystem configured to generate a touch control on the virtual keyboard which allows a user to change dimensions of the virtual keyboard by touching the touch control, so that the virtual keyboard does not obscure the field.

16. The method of claim 15, wherein the virtual keyboard display control subsystem is configured to generate a plurality of touch controls for enabling the user to selectively enlarge and reduce the dimensions of the virtual keyboard.

17. The method of claim 15, wherein the virtual keyboard display control subsystem further is configured to provide a tag on the virtual keyboard that enables the user to drag the virtual keyboard around on the touchscreen display to avoid having the virtual keyboard obscure the field.

18. The method of claim 15, wherein the virtual keyboard display control subsystem is further configured to sense a last spot on the touchscreen display that was touched by the user when the user selects the field, and then to generate the virtual keyboard at a location on the touchscreen display that does not obscure the field.

19. The method of claim 15, wherein the virtual keyboard display control subsystem is configured to display a prompt on the virtual keyboard, in response to the user touching a field being displayed on the touchscreen, the prompt requesting the user to touch the touchscreen display at a location on the touchscreen display where keystroke information is to be displayed.

20. The method of claim 15, wherein the virtual keyboard display control subsystem is configured to consider a location that a cursor being displayed on the touchscreen display is at when determining where to initially generate the virtual keyboard on the touchscreen display.
